(19) United States
(12) Patent Application Publication
(10) Pub. No.: US 2022/0196476 A1
(43) Pub. Date: Jun. 23, 2022

(54) METHOD FOR CONFIGURING A SPECTROMETRY DEVICE

(71) Applicant: GREENTROPISM, PARIS LA DEFENSE CEDEX (FR)

(72) Inventors: Antoine LABORDE, ARCUEIL (FR); Clément MERCIER, SAVENAY (FR); Yoann COTE, MONTREUIL (FR); Anthony BOULANGER, Paris (FR)

(73) Assignee: GREENTROPISM, PARIS LA DEFENSE CEDEX (FR)

(21) Appl. No.: 17/600,754

(22) PCT Filed: Apr. 3, 2020
(86) PCT No.: PCT/EP2020/059507

§ 371 Date: Oct. 1, 2021

(30) Foreign Application Priority Data
Apr. 4, 2019 (FR) FR1903613

(51) Int. Cl. G01J 3/42; G01N 21/27; G01J 3/02

(52) U.S. Cl. CPC G01J 3/42; G01J 2003/2873; G01J 3/0256; G01N 21/274

(57) ABSTRACT

A method for configuring a target spectrometry device using a reference spectrometry device. The method involves: acquiring spectral measurements for a set of reference samples with the reference spectrometer and storing the spectral measurements in a reference database; acquiring target spectral measurements for a sub-set of reference samples with the target spectrometer and storing the spectral measurements in a target database; determining an average spectrum for each reference sample from the reference and target spectral measurements; determining a series of spectra for each average spectrum, which includes determining an optical transfer function of the target spectrometer and applying the optical transfer function to each average spectrum measured by the reference spectrometer; and storing the average spectrum and series of spectra of each reference sample in the target database. The determining steps use a computing module. Also, a spectrometry device configured for the method.

### TECHNICAL FIELD

The present invention relates to a method for configuring a target spectrometry device by means of a reference spectrometry device. It also relates to a spectrometry device configured according to this method.

The field of the invention is, non-limitatively, that of the field of spectrometric methods.

### PRIOR ART

Spectrometry is an essential tool in identifying, quantifying and characterising substances, compounds or molecules. It is used in numerous scientific fields, such as physics, organic chemistry, the pharmaceutical field or medicine. Spectrometry is also very important in the industrial field, for example for production quality control, checking mixtures, in-line cleaning or monitoring in methanisation centres.

One of the major advantages thereof is the very rapid detection time.

The response of a spectrometry device consists of an electrical signal proportional to the amplitude of absorption or reflection of a light beam emitted towards the sample or object to be analysed and absorbed or reflected by it. The properties of the samples to be analysed may include, for example, the concentration of any chemical elements (sugar, lipid, contaminant, etc.), the moisture level in a matrix or of protein in wheat, the texture or temperature of carbohydrates, sugars, etc. To associate this electrical signal with a property of the sample, a relationship must be established between the measured signal and the property of the sample. These calibration relationships are stored directly in the spectrometry device or in a module connected directly or indirectly to the spectrometer. Such a database typically comprises relationships for a wide range of types of sample for the analysis of which the spectrometer is intended.

In order to be able to carry out the calibration of a spectrometric apparatus, the latter must previously make spectrometric measurements over a wide range of samples. All the samples may include, for example, a range of various flours, textiles, liquids, etc. These samples are clearly identifiable and can be stored.

Techniques exist for transferring calibration data from a reference measurement device to another measurement device, for example using simulations for reducing or eliminating specific characteristics of the reference device. However, for this purpose it is necessary to make the measurements on the calibration samples with the two devices. A calibration model developed for the reference device can then be applied for the second device.

### DESCRIPTION OF THE INVENTION

One aim of the present invention is to improve the existing techniques.

One aim of the present invention is to propose a method for configuring a target spectrometry device by means of a reference spectrometry device making it possible to choose only a subset of reference samples for implementing the configuration of the target spectrometer, i.e. without its being necessary for all the samples measured by the reference device also to be measured by the target device.

At least one of these aims is achieved with a method for configuring a target spectrometry device by means of a reference spectrometry device, each spectrometry device comprising a spectrometer, each spectrometer comprising a light source and a detector adapted for detecting light radiation emitted by the source and reflected or transmitted by an object, thereby generating spectral measurements, the spectral measurements comprising a series of n spectra for each object and an average spectrum measured for each series of spectra, the method comprising the steps of:
acquiring reference spectral measurements for a set of reference samples by the reference spectrometer and storing spectral measurements in a reference database;
acquiring target spectral measurements for a subset of the reference samples by the target spectrometer and storing the spectral measurements in a target database;
determining an average spectrum for each reference sample from the reference and target spectral measurements, comprising the steps of determining an optical transfer function of the target spectrometer and applying the optical transfer function to each average spectrum measured by the reference spectrometer;
determining a series of n spectra for each average spectrum; and
storing the average spectrum and the series of n spectra for each reference sample in the target database.

The determination steps are implemented by means of a computing module.

The method according to the present invention makes it possible to dispense with the need for measuring all the samples of a reference set with a target spectrometer before being able to proceed with the configuration of said spectrometer. By means of the method according to the invention, a spectral database containing all the spectral measurements of all the samples can be recorded for the target spectrometer, starting from a small volume of measurements and using the measurements made by a reference spectrometer. Advantageously, the method can be applied to any type of target spectrometer.

The reference spectrometer, also referred to as the master spectrometer, may for example be a laboratory spectrometer, or any other type of spectrometer that serves as a reference spectrometer.

The target spectrometer, also referred to as the slave spectrometer, may be a spectrometer of the same type as the reference spectrometer. Typically, the target spectrometer corresponds to a production version of the reference spectrometer.

The target spectrometer may also be a device having technical characteristics different from those of the reference device. The two spectrometers may be distinguished from each other in particular by their measurement method (reflection, transmission or transflection), by their spectral range, their resolution, the sensitivity or the dynamic range. The second spectrometer may for example be a miniaturised spectrometer.

The reference spectrometer is preferably a device the technical specifications of which are better than those of the target spectrometer.

The two spectrometers are preferably sensitive in the visible and/or infrared range of the light spectrum, between approximately 400 nm and 2500 nm.

In general terms, the optical transfer function of a spectrometer corresponds to the impulse response thereof, i.e. the response of a spectrometer at a given wavelength.

According to one example, the optical transfer function is applied to each average spectrum of the reference spectrometer by calculating a convolution product between the optical transfer function and each average spectrum.

According to one embodiment, the method may furthermore comprise a step of minimising the difference between the average spectrum determined and the average spectrum measured by the target spectrometer for each sample of the subset of reference samples.

According to one embodiment, the optical transfer function is determined by at least one technical characteristic of the target spectrometer. This technical characteristic is selected from sensitivity, spectral range or resolution. Preferably, these three technical characteristics of the target spectrometer are used for determining the optical transfer function.

These technical characteristics of the target spectrometers may be supplied by the manufacturer. When they are not supplied, they can be estimated or measured.

According to one embodiment, the step of determining a series of n spectra comprises the steps of:
estimating a covariance matrix from the spectra measured by the target spectrometer; and
determining n Gaussian vectors from the covariance matrix for each reference sample.

Preferentially, the covariance matrix is estimated from the spectra measured by the target spectrometer and the noise associated with these measurements.

This is because estimating the covariance matrix is more reliable by taking into consideration the high-frequency noise, or measurement noise, present in all the physical measurements. The dependency of the intensity of the measured optical signal on the noise can be modelled and used for refining the estimation of the covariance matrix.

According to another aspect, the invention relates to a spectrometry device comprising a spectrometer comprising a light source, a light-radiation detector and an electronic module, the spectrometry device being configured according to the method according to the invention.

The target spectral database may in particular be recorded in an electronic module forming part of the spectrometer or being connected thereto. This electronic module may for example comprise an internal memory of the spectrometer or an embedded platform, such as a microcomputer, a smartphone and/or a remote server. The electronic module may be connected directly or indirectly to the spectrometer, for example via the cloud or any other communication device.

In a similar manner, the calculation module performing the steps of determining and estimating the method according to the invention may form part of the spectrometer or be connected thereto.

These two modules may consist either of a single module, or two distinct modules.

According to a preferred embodiment, the spectrometer may be a miniaturised spectrometer. In this case, it may comprise a fibre-optic probe adapted for making remote measurements.

### DESCRIPTION OF FIGURES AND EMBODIMENTS

Other advantages and features will emerge from the examination of the detailed description of in no way limitative examples, and of the accompanying drawing, on which:

FIG. 1 is a schematic representation of a spectrometry device according to an embodiment of the invention,

FIG. 2 is a schematic representation of a method according to an embodiment of the invention.

Naturally the embodiments that will be described hereinafter are in no way limitative. It will be possible in particular to imagine variants of the invention comprising only a selection of features described hereinafter isolated from the other features described, if this selection of features is sufficient to confer a technical advantage or to differentiate the invention with respect to the prior art. This selection comprises at least one preferably functional feature without structural details, or with only part of the structural details if this part only is sufficient for conferring a technical advantage or for differentiating the invention with respect to the prior art.

In particular, all the variants and all the embodiments described can be combined together if nothing opposes such combination on a technical level.

The invention relates to a method for configuring a target spectrometry device by means of a reference spectrometry device.

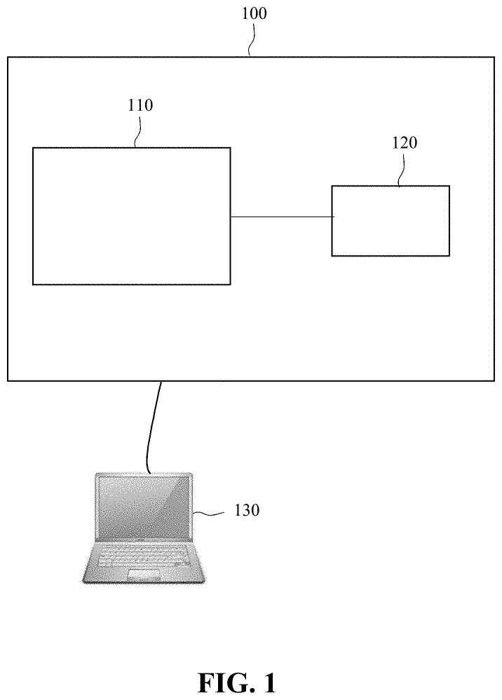

FIG. 1 shows schematically a spectrometry device 100, comprising a spectrometer 110 and an electronic module 120.

Each spectrometer 110 is equipped at least with a light source and a detector. Light is directed onto an object or sample to be analysed, and the radiation transmitted or reflected is captured by the detector.

The spectrometry device 100 can be controlled by means of an external control unit 130.

The electronic module 120 is configured for processing the optical signals detected and thus analysing the sample by means of a database recorded therein and comprising in particular calibration equations. Each spectrometer 110 can be characterised by an optical transfer function or, equivalently, by its impulse response.

In general terms, a spectral measurement corresponds to the measurement of the absorbance of light for each wavelength λ in a spectral range Λ. To obtain the absorbance of a material, the intensity I(λ) reflected or transmitted by the sample is measured and is compared with a reference intensity I₀(λ) in accordance with the following equation:

$$A ( λ ) = l o {g}_{10} ( \frac{{I}_{0} ( λ )}{I ( λ )} ) . \qquad [ Math 1 ]$$

The reference intensity I₀(λ) is measured on a reference sample made from inert material. This reference sample is in general a material used for measuring the spectral distribution of the light source of the spectrometer.

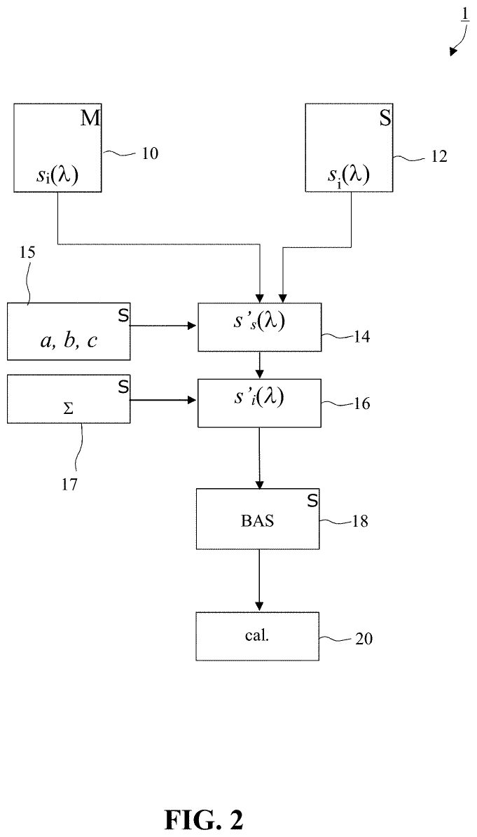

FIG. 2 illustrates schematically the steps of a method 1 according to one embodiment of the invention.

Initially, in a step 10 of the method 1, with a first spectrometer M, the spectra sᵢ of a set A of samples are measured. This first spectrometer M is called the master spectrometer or reference spectrometer. These measurements are stored or recorded in a so-called reference spectral database BAM.

In a step 12, the spectra sᵢ for a subset B of samples are measured with a second spectrometer S, referred to as the target or slave spectrometer. These measurements are stored or recorded in a so-called target spectral database BBS. The subset B forms part of the set A of samples.

The reference samples of the set A are preferably made from an inert material, for example wood, flours, wheat, plastics materials or oils. It is presumed that, for the reference samples of the set A, only few chemical properties vary from one sample to another. It is in fact preferable for the reference samples to have similar chemical properties for their spectra not to be subjected to an excessively large number of independent variability sources. For example, a set of flours with different protein levels may have a source of variability that is the protein level. If all the flours contain various types of flour (for example T45, T55), there is an additional source of variability. The greater the number of sources of variability, the larger must be the size of the subset B.

The measurements 10, 12 of the spectra are made under the same conditions. The samples are measured by means of the spectrometers M and S by implementing n repeated scans at various physical points on each sample. The measurement method (reflectance, transmittance or transflectance) may be different for the two spectrometers M and S.

Typically, each spectra measurement is a matrix of m columns and rows, where m corresponds to the number of wavelengths used for measuring a spectrum and n is the number of spectra measured per sample. This is because, owing to a number of factors, no two spectrum measurements (scans) on the same sample are identical. These factors include, for example, the heterogeneity of the sample, the electronic noise of the measurement apparatus, the imperfection of the optical components of the apparatus, and the measurement conditions such as humidity or air temperature. All the spectral measurements of a set of samples may be stored in a single file. Alternatively, it is possible to process one file per spectral measurement.

From the n spectra for one sample, it is possible to obtain an average spectrum representing the average of the n spectra.

With reference to FIG. 2, in a step 14, the form of an average spectrum s′_{S}(λ) for each sample in a set A is determined for the spectrometer S. To do this, the average spectra obtained from the spectral measurements by the reference spectrometer, referred to as reference average spectra, are used for implementing a resampling.

For this step 14, it is necessary to know the following technical characteristics and parameters of each spectrometer M and S: the spectral range Λ_{M}, Λ_{S}, the resolution r_{M}, r_{S} and the sensitivity s_{M}, s_{S}.

The spectral range A is the set of all the wavelengths used for making a spectral measurement. This information can be found, for example, in the measurement files or on a technical note of the spectrometer, supplied by the manufacturer. The spectral range can be expressed in wavelengths λ with the nanometre (nm) as the unit or in wave numbers σ with cm⁻¹ as the unit. The two units used must be identical between the two spectrometers M and S. The units can be converted in accordance with the following equation:

$$λ = \frac{1 {0}^{7}}{σ} . \qquad [ Math 2 ]$$

To resample the reference average spectra, an estimation of the optical transfer function, or of the impulse response, CMS of the target spectrometer is implemented. This is because the resolution of the target spectrometer is simulated from the reference average spectra. To do this, a convolution product between the transfer function of the target spectrometer and the reference average spectra is calculated. In this way the target average spectra able to be measured with the target spectrometer are obtained. The impulse response may for example have a Gaussian form, in accordance with the following general equation:

$${C}_{M \to S} ( x ) = a {e}^{\frac{- {( x - b )}^{2}}{2 {c}^{2}}} , \qquad [ Math 3 ]$$

wherein a is the amplitude, b is the abscissa for the value a, and c the variance, i.e. the width of the Gaussian bell curve. In this equation, x represents a wavelength.

The form of the impulse response is characterised by the three constants a, b and c. These constants will be determined subsequently by means of the technical information of the spectrometers M and S. The parameters a, b and c are therefore involved in determining the average spectrum s′_{S}(λ) (step 15 of FIG. 2).

The impulse response is used in the following manner. For each wavelength λ_{S} in the spectral range Λ_{S}, it is necessary to find the value closest to the wavelength λ_{M} in the spectral range Λ_{M}. The constants a, b and c are next calculated for each wavelength thus identified in the range Λ_{S}. Finally, the function CMS is applied to the reference average spectra.

It should be noted that the impulse function is defined for each wavelength λ_{S} in the spectral range Λ_{S}, just like the constants a, b and c.

The parameter a_{λ} is proportional to the sensitivity of the target spectrometer S. The parameter a_{λ} can be calculated using spectra measured in the following manner:

$$\begin{matrix}{a}_{λ} = \frac{{s}_{S} ( λ )}{{s}_{M} ( λ )} & [ Math 4 ] \\ where & \\ {a}_{λ} = {s}_{S} ( λ ) , & [ Math 5 ]\end{matrix}$$

where s_{S}(λ) corresponds to an average spectrum measured by the target spectrometer and s_{M}(λ) corresponds to an average spectrum measured by the reference spectrometer, referred to as the reference average spectrum. This is because the first of these equations takes account of the fact that the impulse response of the target spectrometer does not necessarily have an identical gain over the entire spectral range. There may for example be a loss of sensitivity at the end of the spectral range.

The parameter b_{λ} represents the wavelength in the reference spectral range Λ_{M} that is closest to the wavelength λ_{S} in question:

$${b}_{λ} = {argmin}_{λ ∈ {Λ}_{M}} \vert λ - {λ}_{S} \vert . \qquad [ Math 6 ]$$

The parameter c_{λ} is determined by means of the resolution of the target spectrometer at each wavelength. The resolution is defined as the width at half height (FWHM) of a supposed Gaussian impulse response of the target spectrometer. It is often given by the manufacturer on the technical note of the spectrometer. It can also be obtained by measuring a monochromatic light source with the spectrometer. The FWHM may vary in the spectral range. The parameter c_{λ} can be obtained by making the following calculation:

$${c}_{λ} = \frac{F W H M}{2 \sqrt{2 ln ( 2 )}} . \qquad [ Math 7 ]$$

Finally, the average spectrum determined for the target spectrometer S is obtained by means of the impulse response CMS of the target spectrometer and of the reference average spectrum s_{M} at each wavelength λ_{S} of the spectral range Λ_{S}. Thus, a simulated average spectrum s′_{S}[λ] can be obtained by:

$${s}_{S}^{′} [ λ ] = {\sum }_{i ∈ {Λ}_{M}} {C}_{M \to S}^{λ} ( i ) \cdot {s}_{M} ( i ) , \qquad [ Math 8 ]$$

where s_{M}(i) represents a point in the reference average spectrum.

The calculation Math 8 is repeated for each wavelength of the spectral range Λ_{S} of the target spectrometer S in order to obtain the complete average spectrum for the target spectrometer.

The calculation is repeated for each reference sample in the set A, in order to obtain a calculated average spectrum s′_{S} for each sample.

The quality of the determination or simulation of the average spectra depends on the quality of the determination or estimation of the values of the three parameters a_{λ}, b_{λ}, and c_{λ}. This is because it may happen that the technical information available for the target spectrometer S is insufficient for determining these values with satisfactory precision. It is then necessary to define a criterion for good modelling of the spectra using the reference database.

According to an advantageous embodiment of the invention, the method comprises a step of adjustment, for each sample of the subset B, between the calculated average spectrum s′S and the measured average spectrum s_{S} by the target spectrometer. This is possible because the reference and target databases BAM and BBS are two coherent databases, i.e. based on measurements made on the same samples.

For this adjustment step, it is possible to use, for example, the residual sum of squares (RSS), in accordance with the following equation:

$$R S S = {\sum }_{λ ∈ {Λ}_{S}} {( {s}_{S}^{′} [ λ ] - {s}_{S} [ λ ] )}^{2} . \qquad [ Math 9 ]$$

This function can be optimised using a brute force strategy for the parameters a_{λ}, b_{λ}, and c_{λ}, by exhaustively verifying a set of values for each parameter.

The step 14 of determining the average spectra s′S ends after the adjustment step. Thus a target database BAS is obtained, stored in the electronic module of the target device, which is populated by an average spectrum for each sample of the set A.

It is then necessary to obtain all the spectral measurements s′ᵢ, i.e. a series of n spectra for each of the average spectra s′S calculated. To do this, in a step 16 of generating variables, n spectra are generated from each average spectrum s'_{S}.

For this step 16, it is presumed that the variations in the spectral measurements for the same sample follow a multivariate normal law. In this case, the probability density function is a Gaussian function defined by:

$${f}_{μ , Σ} ( x ) = \frac{1}{{( 2 π )}^{N / 2} {\vert Σ \vert}^{1 / 2}} {e}^{\frac{- 1}{2} {( x - μ )}^{T} {Σ}^{- 1} ( x - μ )} , \qquad [ Math 10 ]$$

where μ represents the expected value, Σ represents the covariance matrix and |Σ| the determinant of the covariance matrix. N is the number of variables, i.e. the number of wavelengths λ_{S} in the spectral range of the target spectrometer S (N=card(Λ_{S})). T signifies the transpose of a matrix.

In the present case, μ is defined by the average spectrum s′_{S} calculated according to Math 8. The covariance matrix Σ is unknown.

In a step 17 of the method 1, The covariance matrix is estimated. To do this, the spectra measured for the samples of the subset B and stored in the database BBS in the target spectrometer S are used. This is because this database can be represented by a matrix X having i rows and j columns. The spectral measurements are organised in rows so that the variables (i.e. the wavelength λ_{S}) are in columns.

According to this notation, the column i of the matrix X is denoted by Xᵢ, and μᵢ expresses the average of the column i of the matrix X in accordance with the following equation:

$${\hat{μ}}_{i} = \frac{1}{N} {\sum }_{j = 1}^{N} {X}_{i , j} , \qquad [ Math 11 ]$$

The equation Math 11 represents the absorbance of the average spectrum at the i^{th} wavelength.

The covariance matrix Σ is a square matrix of size N×N. It is estimated by means of the matrix X in accordance with the following equation:

$$Σ = \frac{1}{N} {X}^{T} X . \qquad [ Math 12 ]$$

Once the covariance matrix Σ has been estimated, the values of the probability density function can be determined in accordance with the equation Math 11. This determination can be made, for example, by means of suitable software. By way of example, known statistical software capable of generating a normal (or Gaussian) multivariate distribution or programming languages such as MATLAB or C can be used for implementing this generation of values.

By means of the equations Math 11 and 12, it is then possible to determine n Gaussian vectors. The choice of the number n is arbitrary. These Gaussian vectors represent the spectra s′ᵢ(λ) simulating spectra measured with the target spectrometer S.

In summary, the covariance matrix Σ contains all the information relating to the variability of the spectrometric measurements from one scanning to the other for a sample. As described in the above embodiment, the estimation of Σ is based on all the samples of the subset B for it to be of sufficient quality. Depending on the nature of the samples, only a few samples may however suffice to obtain a good estimation of Σ. Moreover, if the complete set A of samples contains very different chemical materials or substances, it may be useful to measure more samples with the target spectrometer for estimating Σ.

Finally, it is also possible to obtain a more reliable estimation of the covariance matrix Σ by taking into consideration the high-frequency noise, or measurement noise. The measurement noise can be recognised in the spectral data measured by its high-frequency signal, which is modulated by the spectral signal per se.

This type of noise can be calculated using the diagonal terms of the covariance matrix. The noise depends on the level of absorbance measured. The smaller the signal by the detector, the higher the absorbance and also the greater the influence of the measurement noise.

The measurement noise can be characterised by its variance V:

V=E[(b−E[b])²], [Math 13]

where E represents the average operator and b is the measured noise signal.

It is possible to find a relationship between the variance of the measurement noise and the level of absorbance in the measurement. For example, this relationship can be estimated for a spectrometer by using a collection of samples with various absorbance levels. According to a variant, Spectralon® materials with various diffuse reflection levels (for example 10%, 20%, 30% . . . 99%) are suitable for this estimation. Other materials can also be used.

Each material is measured with the spectrometer and the data are stored in a matrix, in the same manner as the spectral measurements previously mentioned, i.e. in a matrix of m columns and n rows, where m corresponds to the number of wavelengths used for the measurement and n is the number of spectra measured per sample. Next, for each spectrum, the noise signal must be separated from the measurement signal using a technique for processing the signal adapted for this purpose. The technique may involve, for example, a low-pass filter, a bandpass filter or a Savitzsky-Golay filter. Any other filter capable of reducing the high-frequency noise may also be used.

Applying such a filter to a spectral measurement s results in spectral data so not containing any noise. The noise br itself can be calculated in accordance with the equation br=s₀−s.

The variance of the noise is determined by means of the equation Math 13 for each absorbance level. Then a table of data is obtained containing the variance of the noise in the first column and the absorbance level in the second column. The relationship between the two columns of this table is modelled by means of an exponential curve in order to obtain the equation V=f(A), where A represents the absorbance level. The exponential curve has the form described in the following equation:

f(x)=αe^{βx}, [Math 14]

where the parameters α and β can be calculated using standard statistical software adapted for optimising the modelling of V(A) in order to best adjust it to the measurement data.

Once the relationship between the variance of the noise and the absorbance has been obtained, the diagonal terms Σᵢᵢ of the covariance matrix Σ as described above are modified by adding thereto the variance V of the noise corresponding to the absorbance level in question:

Σ′ᵢᵢ=Σᵢᵢ+α(i)e^{β(i)μ(i)}, [Math 15]

for 1≤i≤N, and where α(i) and β(i) represent the optimised parameters of the exponential equation Math 14 between the absorbance and the variance of the noise. N is the number of wavelengths of the spectral range of the target spectrometer, and also the number of pairs of parameters (α(i), β(i)).

Thus, at the end of the step 16 of generating variables, for each average spectrum s′_{S} calculated, n spectra s′ᵢ will complete the database BAS. In a recording step 18, the database BAS is then recorded in the electronic module of the target device.

According to one embodiment, the database BAS recorded can then be used for other operations of configuring the target spectrometer S. For example, a step 20 of calibrating the spectrometer can be implemented, in accordance with a calibration method using the calculated spectra s′ᵢ(λ) present in the database.

Other operations can follow the recording of the database, for example the configuration of a chemimetric model, or any other use of the database for statistical work for exploiting measurements of spectra.

Typically, all the determination, calculation and/or estimation steps of the method according to the invention, described above, are implemented by a calculation module. This calculation module comprises at least one computer (as illustrated in FIG. 1 at the reference 130), a central or calculation unit, an analogue electronic circuit (preferably dedicated), a digital electronic circuit (preferably dedicated), and/or a microprocessor (preferably dedicated), and/or software means.

Naturally the invention is not limited to the examples that have just been described and numerous arrangements can be made to these examples without departing from the scope of the invention.

1-9. (canceled)

10. A method for configuring a target spectrometry device by means of a reference spectrometry device, each of the target spectrometry device and the reference spectrometry device comprising a spectrometer, each spectrometer comprising a light source and a detector configured for detecting light radiation emitted by the light source and reflected or transmitted by an object, thereby generating spectral measurements, the spectral measurements comprising a series of n spectra for each object and an average spectrum measured for each series of n spectra, the method comprising the steps of:
acquiring reference spectral measurements for a set of reference samples by the spectrometer of the reference spectrometry device and storing the reference spectral measurements in a reference database;
acquiring target spectral measurements for a subset of the reference samples by the spectrometer of the target spectrometry device and storing the target spectral measurements in a target database;
determining an average spectrum sₛ for each reference sample from the reference spectral measurements and target spectral measurements, comprising the steps of:
determining an optical transfer function of the spectrometer of the target spectrometry device; and
applying the determined optical transfer function to each average spectrum measured by the spectrometer of the reference spectrometry device;
determining a series of n spectra sᵢ (i=1 . . . n) for each average spectrum sₛ; and
storing the average spectrum and the series of n spectra for each reference sample in the target database,
wherein the determination steps are implemented by means of a calculation module.

11. The method according to claim 10, further comprising a step of minimizing a difference between the determined average spectrum sₛ and the average spectrum measured by the spectrometer of the target spectrometry device for each sample of the subset of reference samples.

12. The method according to claim 10, wherein the optical transfer function is determined from at least one technical characteristic of the spectrometer of the target spectrometry device.

13. The method according to claim 12, wherein the at least one technical characteristic is selected from sensitivity, spectral range or resolution.

14. The method according to claim 10, wherein the step of determining a series of n spectra comprises the steps of:
estimating a covariance matrix from the spectra measured by the spectrometer of the target spectrometry device; and
determining n Gaussian vectors from the covariance matrix for each reference sample.

15. The method according to claim 14, wherein the covariance matrix is estimated from the spectra measured by the spectrometer of the target spectrometry device and the noise associated with these measurements.

16. A spectrometry device comprising a spectrometer and an electronic module, the spectrometer comprising a light source and a detector configured for detecting the light radiation emitted by the source and reflected or transmitted by an object, the spectrometry device being configured according to the method of claim 10, wherein the electronic module is configured for storing the database.

17. The spectrometry device according to claim 16, wherein the spectrometer is a miniaturized spectrometer.

18. The spectrometry device according to claim 16, wherein the spectrometer operates in a range of wavelengths between 400 nm and 2500 nm.
